(19) United States
(12) Patent Application Publication
(10) Pub. No.: US 2020/0380335 A1
(43) Pub. Date: Dec. 3, 2020

(54) ANOMALY DETECTION IN BUSINESS INTELLIGENCE TIME SERIES

(71) Applicant: Avast Software s.r.o., Praha 4 (CZ)

(72) Inventor: Martin Neznal, Praha 1 (CZ)

(21) Appl. No.: 16/426,958

(22) Filed: May 30, 2019

(51) Int. Cl. G06N 3/04; G06N 3/08; G06Q 10/06

(52) U.S. Cl. CPC G06N 3/0445; G06Q 10/067; G06N 3/08

(57) ABSTRACT

A method of identifying anomalous traffic in a sequence of commercial transaction data includes preprocessing the commercial transaction data into a sequential time series of commercial transaction data, and providing the time series of commercial transaction data to a recurrent neural network. The recurrent neural network evaluates the provided time series of commercial transaction data to generate and output a predicted next element in the time series of commercial transaction data, which is compared with an observed actual next element in the time series of commercial transaction data. The observed next element in the time series of commercial transaction data is determined to be anomalous if it is sufficiently different from the predicted next element in the time series of commercial transaction data.

### FIELD

The invention relates generally to detection of anomalies in business data, and more specifically to detection of anomalies in a business intelligence time series.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

One common use for Internet-connected computers is to conduct business, such as buying items from online merchants, requesting bids for products or work from various providers, and managing appointments for various types of services such as making an appointment for a haircut or to have a new appliance installed. Using computerized systems to manage business data enables the businesses and the consumers to conduct transactions, verify information, and perform other tasks much more efficiently than if the same business were conducted through personal interaction, and provides electronic records of conducted business that can be used to analyze and manage various aspects of the business.

For example, a business may categorize and compile transactions for items they purchase to keep track of where their greatest costs are, while tracking sales to analyze things like which products sit the longest before being sold or generate the least profit per dollar invested. The amount of data that is captured and that can be analyzed is enormous, and the opportunities for finding meaning within the data are many. But, even though some things such as revenue and items sold are straightforward to track and their meaning is fairly evident, the challenge of knowing what to look for in a broader pool of data and determining what the data means can be daunting. Things like seasonal, weekly, or monthly variations can skew observations and make differentiating normal from abnormal variations difficult. Also, some data changes may be a side effect of preceding changes in other data that are not obvious without a deep understanding of what causes collected data to behave the way it does.

A need therefore exists for analyzing business intelligence data in computerized systems to better detect various patterns or anomalies in data.

### SUMMARY

One example embodiment of the invention comprises a method of identifying anomalous traffic in a sequence of commercial transaction data includes preprocessing the commercial transaction data into a sequential time series of commercial transaction data, and providing the time series of commercial transaction data to a recurrent neural network. The recurrent neural network evaluates the provided time series of commercial transaction data to generate and output a predicted next element in the time series of commercial transaction data, which is compared with an observed actual next element in the time series of commercial transaction data. The observed next element in the time series of commercial transaction data is determined to be anomalous if it is sufficiently different from the predicted next element in the time series of commercial transaction data.

In a further example, the recurrent neural network is trained on windowed sequences from the sequence of commercial transaction data, such as a multiple of a day, a week, a month, or another period over which network data patterns might reasonably be expected or observed to repeat.

In another example, the difference between the predicted next element in the time series of commercial transaction data and an observed actual next element in the time series of commercial transaction data comprise at least one of long short history threshold, self-adapting dynamic threshold, absolute difference, difference relative to either predicted or actual observed next element, z-score, dynamic threshold, or difference between short-term and long-term prediction error.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computer network environment including a network commerce server operable to conduct and record data related to commercial transactions, and to train a recurrent neural network to recognize commercial transaction data anomalies and to monitor commercial transactions for anomalies, consistent with an example embodiment.

FIG. 2 is a chart showing use of a trained recurrent neural network to identify commercial transaction anomalies, consistent with an example embodiment.

FIG. 3 shows a recurrent neural network, as may be used to practice some embodiments.

FIG. 4 is a chart showing preprocessed data sequences provided to the recurrent neural network, consistent with an example embodiment.

FIG. 5 shows how sequential input windows are used to train the recurrent neural network, consistent with an example embodiment.

FIG. 6 is a flowchart showing use of a trained recurrent neural network to detect commercial transaction anomalies, consistent with an example embodiment.

FIG. 7 is a graph showing prediction errors or loss L between recurrent neural network output and observed next network traffic values, consistent with an example embodiment.

FIG. 8 is a flowchart illustrating using a Long-Short History Threshold (LSHT) to determine loss in training the recurrent neural network or a threshold for detecting an anomaly using a trained recurrent neural network, consistent with an example embodiment.

FIG. 9 is a flowchart illustrating using a Self-Adapting Dynamic Threshold to determine loss in training the recurrent neural network or a threshold for detecting an anomaly using a trained recurrent neural network, consistent with an example embodiment.

FIG. 10 shows a flowchart illustrating combining two or more methods to determine whether commercial transaction data is anomalous, consistent with an example embodiment.

FIG. 11 is a flowchart of a method of training a recurrent neural network to identify anomalies in commercial transaction data, consistent with an example embodiment.

FIG. 12 is a flowchart of a method of using a trained recurrent neural network to identify anomalies in commercial transactions, consistent with an example embodiment.

FIG. 13 is a computerized network commerce system comprising a recurrent neural network module, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

The amount of data related to online commercial transactions is growing rapidly with the ever-increasing amount of commerce conducted online, such as buying items from online merchants, requesting bids for products or work from various providers, and managing appointments for various types of services. The collected data comes from a variety of sources such as completed transactions, bids for work, and appointments for services. Online commerce systems enable business and consumers alike to conduct transactions, verify information, and perform other tasks much more efficiently than if the same business were conducted through personal interaction, while providing the electronic records that enable business intelligence metrics to be formulated and compiled.

Business use business intelligence analytics to gain insight into their businesses and to make business decisions, such as tracking transactions for items they purchase to keep track of where their greatest costs are, tracking sales to analyze things like which products sit the longest before being sold, determining which products generate the least profit per dollar invested, number of users, number of views of an advertisement, or the revenue of a certain product. The amount of data that is captured and that can be analyzed is enormous, and the opportunities for finding meaning within the data are many but complex. Even though some things such as revenue and items sold are straightforward to track and their meaning is fairly evident, the challenge of knowing what to look for in a broader pool of data and determining what the data means can be daunting. Normal variations over the course of different seasons, months, or weeks can skew observations and make differentiating normal from abnormal variance difficult. Also, some data changes may be a side effect of other more significant changes that are more difficult to detect, or may be masked as subtle changes in several different pieces of data such that they are not obvious without a deep understanding of what causes collected data to behave the way it does.

Some examples presented herein therefore provide methods and systems for analyzing business intelligence data in computerized systems to better detect various patterns or anomalies in data. This is achieved in some examples by monitoring commercial transaction data using a long short term memory (LSTM) model such as a recurrent neural network or convolutional neural network to monitor and characterize normal commercial transaction patterns, enabling the neural network to detect commercial transaction patterns that are abnormal. In a more detailed example, a series of commercial transactions is broken down into a time series of high-dimensional inputs, where the dimensions are features of the commercial transactions such as the country or zip code of a transaction or an item code identifying the product or service provided. These high-dimensional inputs are input to the LSTM neural network in windowed sequences, both to train the network and subsequently to evaluate commercial transactions for anomalies. In a more detailed example, commercial transaction features are compiled per hour, per day, or over other time periods during which commercial transactions are observed to be similar or have repeating patterns.

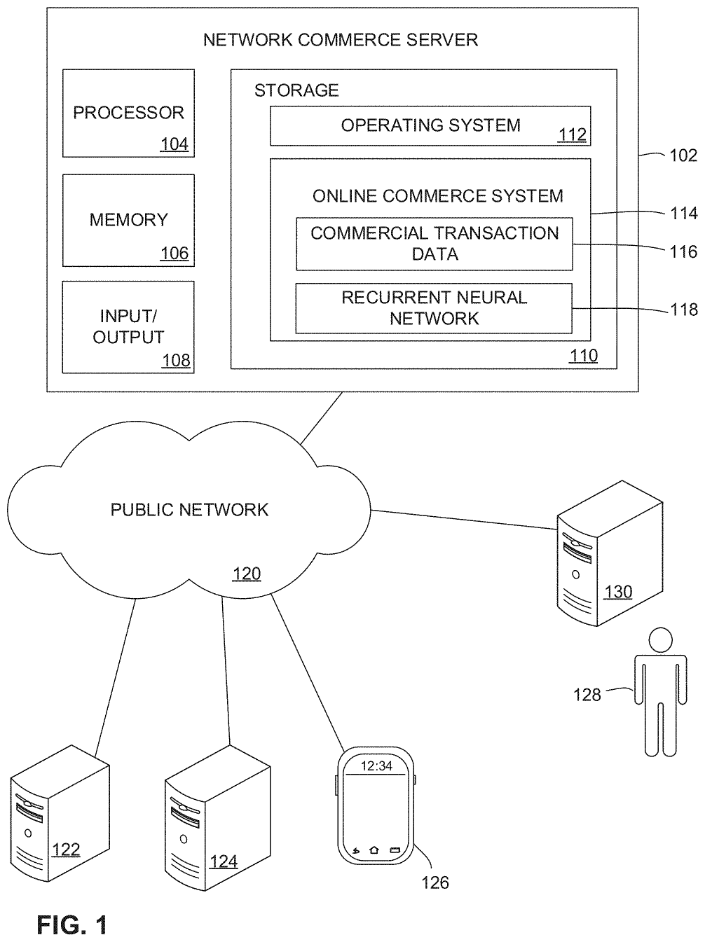

FIG. 1 shows a computer network environment including a network commerce server operable to conduct and record data related to commercial transactions, and to train a recurrent neural network to recognize commercial transaction data anomalies and to monitor commercial transactions for anomalies. Here, a network commerce server 102 comprises a processor 104, memory 106, input/output elements 108, and storage 110. Storage 110 includes an operating system 112, and an online commerce system 114 that generates commercial transaction data 116 from various commercial transactions conducted via the server as well as a recurrent neural network 118 that is trained using the commercial transaction data 116 to detect anomalies in commercial transaction data. The recurrent neural network 118 is trained such as by providing an expected output for a given sequence of input and backpropagating the difference between the actual output and the expected output using training data historic commercial transaction data 116. The recurrent neural network trains by altering its configuration, such as multiplication coefficients used to produce an output from a given input to reduce or minimize the observed difference between the expected output and observed output. The commercial transaction data 116 includes data from a variety of normal commercial transactions that can be used to train the recurrent neural network, and in a further example includes anomalous commercial transactions that can be used to help train the neural network to better identify anomalies. Upon completion of initial training or completion of a training update, the recurrent neural network 118 monitors live commercial transactions such as in real time or in near-real time to detect anomalies in commercial transactions as they occur or shortly thereafter.

The network commerce server is connected via a public network 120, such as the Internet, to one or more other computerized systems 122, 124, and 126, through which commercial transactions are conducted. A network commerce system user 128, such as a server administrator, uses a computer system 130 to manage the operation of network commerce server 102, and to receive reports of anomalies in commercial transaction data from the online commerce system 114.

In operation, the recurrent neural network module 118 is operable to scan commercial transactions conducted by online commerce system 114 in real time or in near-real time, such as by receiving new commercial transaction data as it is recorded in 116, or by periodically processing new commercial transaction data from commercial transaction database 116. If the recurrent neural network module determines that the commercial transaction data is anomalous, it notifies the user or performs other such functions to alert the online commerce system's operators that commercial transactions are not proceeding as they normally do.

The recurrent neural network at 118 in this example is trained the same server that is used to scan commerce data for anomalies, but in other examples is trained separately such as in a dedicated server. The commercial transaction data 116 used to train the recurrent neural network in this example comes from the same server as is used to train the recurrent neural network, but in other examples other commercial transaction data, such as commercial transaction data from one or several other servers, may be used to train the recurrent neural network. In a still further example, the recurrent neural network 118 is trained on a server such as 102, and is then distributed to one or more other serves, gateways, or other devices to monitor commercial data for anomalies.

The commercial transactions processed in the recurrent neural network in this example are broken into time segments, such as hourly, daily, monthly, or other such segment, and are in further examples evaluated by preprocessing the data into a high-dimensional space reflecting various characteristics of the data such as the number of items bought, the classification of items bought, the zip code or other location information of the purchaser, and the like. In a further example, the high-dimensional space further includes time-based information such as day of the week or hour of the day during which a transaction is conducted. In this example, many tens to hundreds of such features are analyzed and comprise different input dimensions provided to the recurrent neural network from the preprocessor.

The preprocessor also cleans the data by removing empty or null values from being presented as inputs to the recurrent neural network. Time series are created for various combinations of measures such as bookings, installations, sales, etc., and measures such as physical location, software version or other product identifier, number of products or services bought, identity of each product or service bought, etc. In a more detailed example, time series for each combination of dimension and measure are created, and time series that are known to not be of interest are filtered out or not calculated.

The preprocessed high-dimensional data is provided to the recurrent neural network in a time series, such as an input window having a certain length or window history of data. The recurrent neural network process the data in a manner that uses both prior state data and current state data to predict the next data likely to be observed in the commercial transaction data series, and in training compares the actual next data with the predicted next data and adjusts the network parameters based on the difference between actual and predicted next data (or the loss) to learn to more accurately predict the next commercial transaction data. As this learning process is repeated over large volumes of training data, the recurrent neural network learns to more accurately predict the next network data from a sequence commercial transaction data. After training, the same recurrent neural network is able to recognize when anomalies occur in commercial transaction data such as where the difference between predicted and actual commercial transactions is significantly larger than might typically be expected. Detection of anomalies in a more detailed example use a difference threshold, z-score, dynamic threshold, differences between short-term and long-term prediction error, or other such methods or combinations of such methods.

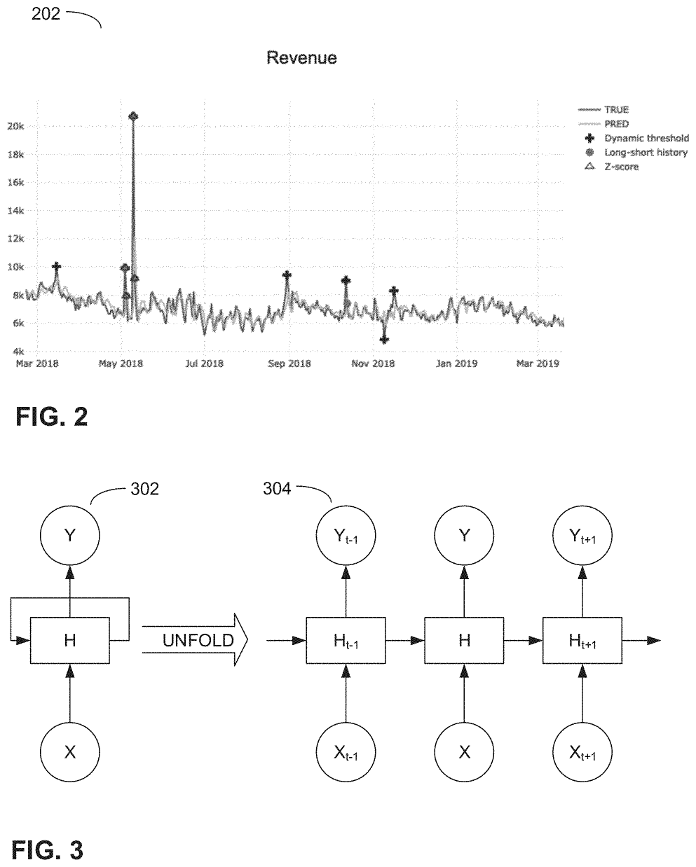

FIG. 2 is a chart showing use of a trained recurrent neural network to identify commercial transaction anomalies, consistent with an example embodiment. Here, the predicted occurrence of an event, such as revenue of a product or other such event characterized by the high-dimensional preprocessing of the network data, is charted. The bottom line, and generally more compact line, shows predicted number of events based on prior data used to train the recurrent neural network, while the blue line shows the actual observed number of events. In May 2018, a data anomaly occurred, such as where an external force temporarily increased demand for the product, resulting in a true observed number of events that is significantly higher than the predicted number of events. This deviation or difference is observed as an anomaly in commercial transaction data, and can be used to indicate portions of the time series where commercial transactions deviate from historic norms.

In one example, a simple threshold difference between the expected next commercial transaction data and the observed next commercial transaction data, either numeric difference or percentage difference, is used to determine whether a commercial transactional anomaly is present. In other examples, statistical methods such as z-score evaluation or other variance metrics are used to determine the degree of variance from the expected score. Similarly, some examples use dynamic thresholds, allowing the threshold for detecting an anomaly to vary depending on different observed degrees of variance in normal commercial transactional data, or use differences between short-term and long-term prediction errors to identify anomalies.

FIG. 3 shows a recurrent neural network, as may be used to practice some embodiments. Here, a recurrent neural network having sequential inputs X and generating sequential outputs Y is shown at 302, where H is the recurrent neural network function that uses both prior state data and the input X to produce the output Y. There are many variations of input formats X, output formats Y, and network node formats and configurations H that will work to generate a useful result in different example embodiments. In the example of FIG. 3, the recurrent neural network is also shown unfolded over time at 304, reflecting how information from the neural network state at H used to produce output Y from input X is retained and used with the subsequent input Xₜ₊₁ to produce the subsequent output Yₜ₊₁. The outputs Y over time are therefore dependent not only on the current inputs at each point in the sequence, but also on the state of the neural network up to that point in the sequence. This property makes the neural network a recurrent neural network, and makes it well-suited to evaluate input data where sequence and order is important, such as natural language processing (NLP).

In a more detailed example, the recurrent neural network of FIG. 3 can be used to evaluate a commercial transaction data stream for anomalies, outputting a result at each step predicting the next commercial transactional data element. Similarly, the recurrent neural network of FIG. 3 can be trained by providing the known next commercial transactional data element from a training set of data as the desired output Yₜ₊₁, with the difference between observed and expected outputs output Yₜ₊₁ provided as an error signal via backpropagation to train the recurrent neural network to produce the desired output.

In a further example, training is achieved using a loss function that represents the error between the produced output and the desired or expected output, with the loss function output provided to the recurrent neural network nodes at Hₜ and earlier via backpropagation. The backpropagated loss function signal is used within the neural network at Hₜ, Hₜ₋₁, Hₜ₋₂, etc. to train or modify coefficients of the recurrent neural network to produce the desired output, but with consideration of the training already achieved using previous training epochs or data sets. Many algorithms and methods for doing so are available, and will produce useful results here. In operation, the difference between the output of the neural network and the next commercial transactional data element in a series is compared against a threshold to determine whether the observed next commercial transactional data element is anomalous, where the threshold is selected to provide an acceptable sensitivity rate.

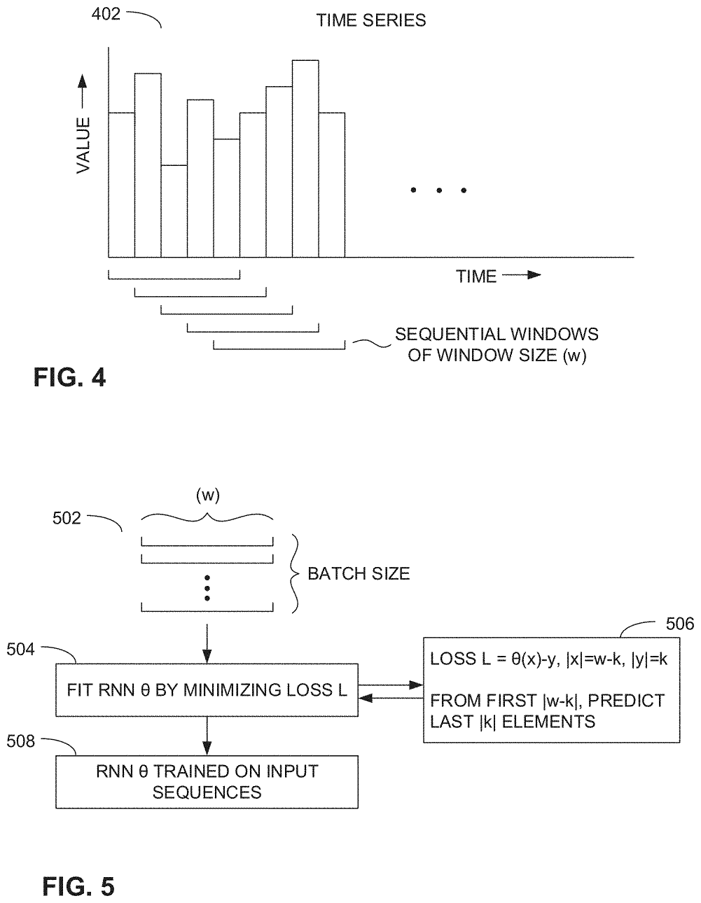

FIG. 4 is a chart showing preprocessed data sequences provided to the recurrent neural network, consistent with an example embodiment. The chart shows generally at 402 a variety of input values of preprocessed network traffic data, such as login attempts per hour, over time. The input values are further grouped into windowed segments of size (w), with sequential segments in this example overlapping significantly as sequential windows advance by one additional input record. Each window comprises a different set of inputs to the recurrent neural network, whether training the neural network or using a trained neural network to evaluate a network data stream for anomalies.

In the example of FIG. 4, the window size for the one-dimensional input shown is five records, such as five hours of commercial transactions, but in many other examples will be longer, such as a day, week, or months' worth of commercial transactions. These overlapping sequences are extracted are therefore each the same size, extracted from the time series of observed commercial transaction data. In many such examples, some or many additional dimensions of input data will also be processed, such as other characteristics of commercial transaction data including price, item identity, number of items purchased in the transaction, number of previous transactions for the customer, time since the last transaction for the customer, etc.

These windowed time series of data are provided to the network during training with the knowledge of the next element in the data series outside the input window, which is used to train the recurrent neural network to predict the next data element. In operation, the windowed data is provided as an input to the recurrent neural network to generate a predicted output, which is subsequently compared to the actual output such that a difference between the predicted output and observed actual output is used to indicate whether the commercial transaction data is anomalous or normal.

FIG. 5 shows how sequential input windows are used to train the recurrent neural network, consistent with an example embodiment. Here, input sequences (x) of size (w) are shown at 502, derived from a time sequence of preprocessed data as shown in FIG. 4. A set of input sequences comprise a training batch, with a batch size of the number of input sequence windows as shown at 502. The training batch of windowed, preprocessed network data is then used to fit the recurrent neural network by minimizing loss as previously described, such as by using backpropagation and a loss function to change coefficients of the recurrent neural network to reduce the loss observed between the neural network's output and the actual next data element in the sequence. This is achieved by providing each windowed sequence (w) as an input to the recurrent neural network, which tries to predict the next (k) values from the set of input values (x) or (w-k) as shown at 506. A loss L is computed based on the difference between the next (k) values and the neural network's output θ(x), and used to adjust the weights of the recurrent neural network's nodes to better predict outputs. This process is repeated for all input sequences in a training batch, and in a further example for multiple training batches, until acceptable prediction results are achieved and the recurrent neural network output is trained at 508.

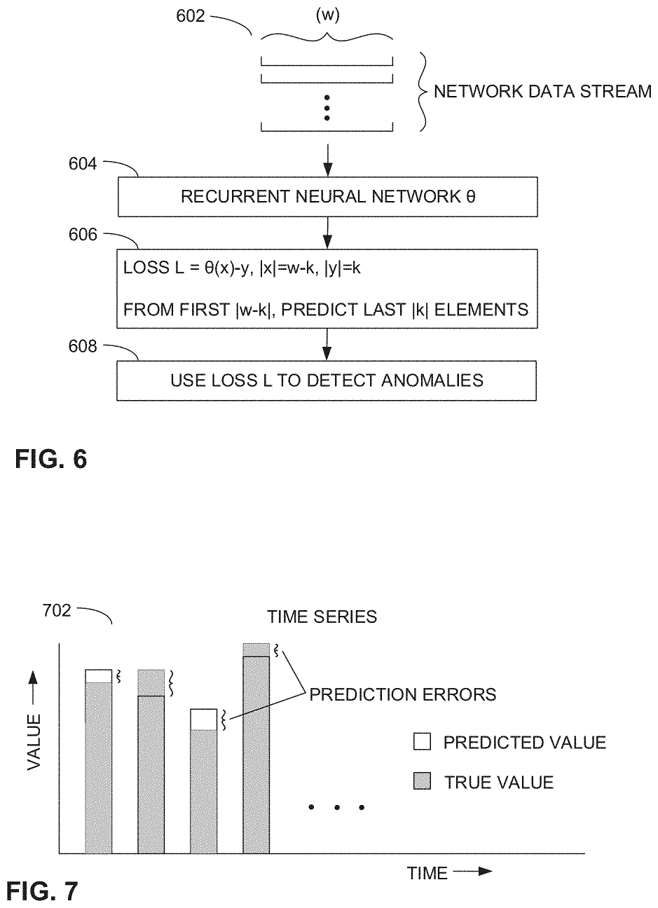

FIG. 6 is a flowchart showing use of a trained recurrent neural network to detect commercial transaction anomalies, consistent with an example embodiment. Here, windowed input sequences (x) of size (w) are again provided from the commercial transaction data stream at 602 to the recurrent neural network inputs, and the recurrent neural network generates an output θ(x) at 604. The output is compared to the actual observed next element or elements (k) in the commercial transaction data sequence at 606, and a loss function L is calculated reflecting the difference between the next (k) values and the neural network's output θ(x). The loss L, or difference, is used along with statistical methods such as a threshold or z-score to determine whether an anomaly has been detected at 608.

FIG. 7 is a graph showing prediction errors or loss L between recurrent neural network output θ(x) and observed next commercial transaction data values (k), consistent with an example embodiment. As shown generally at 702, preprocessed network data values observed over time are also predicted by the recurrent neural network based on prior observed network data values, and the difference is observed as a loss L or prediction error. The white bars in the graph represent the recurrent neural network's predicted values θ(x), derived from prior observed commercial transaction data values (x) input to the recurrent neural network. The gray bars in the graph represent the true, observed next commercial transaction data values (k), and the difference between the predicted values θ(x) and the observed next network traffic data (k) is the prediction error or loss L.

The size of this prediction error or loss L is used to determine whether the observed commercial transaction data values (k) deviate sufficiently from the predicted commercial transaction data values θ(x) to be considered a commercial transaction anomaly, such as by determining whether the prediction error exceeds an absolute threshold, determining whether the prediction error exceeds a threshold determined relative to either the predicted or true network traffic data value, or determining whether the prediction error meets other statistical criteria such as exceeding a z-score or deviation from expected variation between the predicted and true, observed network traffic values. When the prediction error exceeds the threshold or statistical criteria, it is considered an anomaly and is flagged for reporting such as to a user or administrator.

In another example, the prediction error (loss) between the predicted and observed next commercial transactional data is based not only difference of error for one data element, but also on some history of data. These include use of methods termed Long Short History Threshold, Self-Adapting Dynamic Threshold, and combined methods.

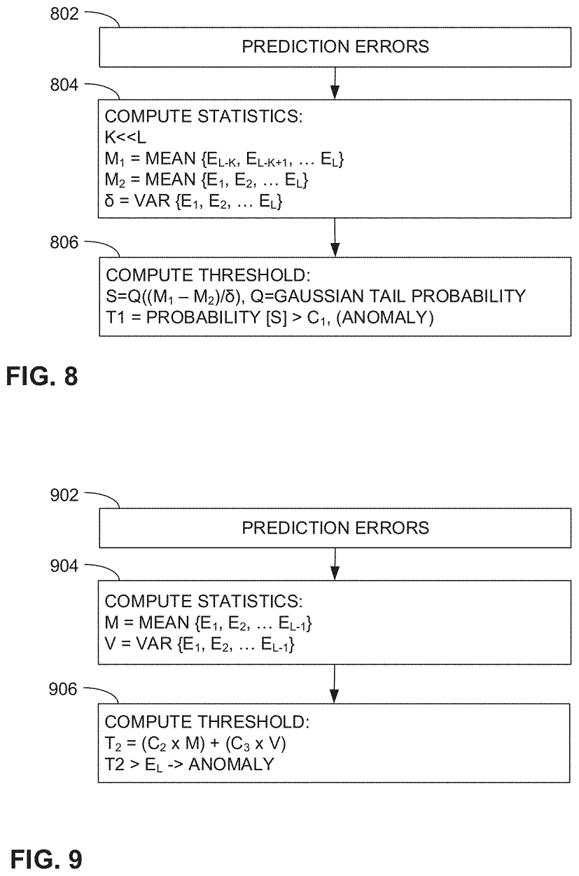

FIG. 8 is a flowchart illustrating using a Long-Short History Threshold (LSHT) to determine loss in training the recurrent neural network or a threshold for detecting an anomaly using a trained recurrent neural network, consistent with an example embodiment. This method takes as input the prediction errors at 802, and a user parameter, constant C₁. At 804, three values are calculated: mean of short history of errors M₁ (e.g. last 2 or 10 errors), mean of long history of errors M₂ (ideally 1000+), and variance δ of long history of errors. Then the Gauss tail probability of the difference of the two means is divided by the variance at 806. This value S expresses the “anomalousness” of the event. The closer this number is to 1, the more anomalous it is. The constant C₁ determines the threshold for this probability, common values can be 0.99, 0.95, or other, depending on the application.

FIG. 9 is a flowchart illustrating using a Self-Adapting Dynamic Threshold to determine loss in training the recurrent neural network or a threshold for detecting an anomaly using a trained recurrent neural network, consistent with an example embodiment. At 902, prediction errors are provided, and at 904, the mean and variance of the last L prediction errors (without the L-th error) are calculated. It accepts as input two constants, C₂ and C₃, which determine the importance of the mean and variance. Common values can be for example C₂=2 and C₃=1. If the value of the threshold (which is sum of these statistics multiplied by the constants) is higher than L-th error, then the algorithm flags this event E as anomalous at 906.

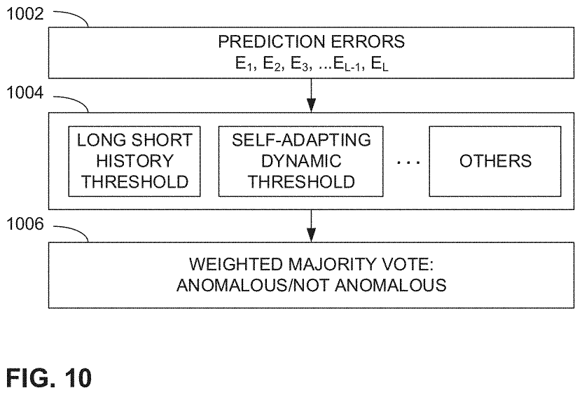

Although the two methods presented above can be used independently for determining a loss function or for detection of anomalies, some examples combine these or other methods. FIG. 10 shows a flowchart illustrating combining two or more methods to determine whether commercial transaction data is anomalous, consistent with an example embodiment. Prediction errors 1002 are provided to two or more different methods of determining whether transaction data is anomalous, including long short history threshold, self-adapting dynamic threshold, and other methods such as mean square error, z-score, Grubbs test, autocorrelation, isolation forests, etc., at 1004. Each of these methods selected in a particular embodiment calculate a determination or score indicating whether the transaction data is anomalous, and a weighted majority vote is calculated at 1006 that finally determines whether the event is anomalous or not.

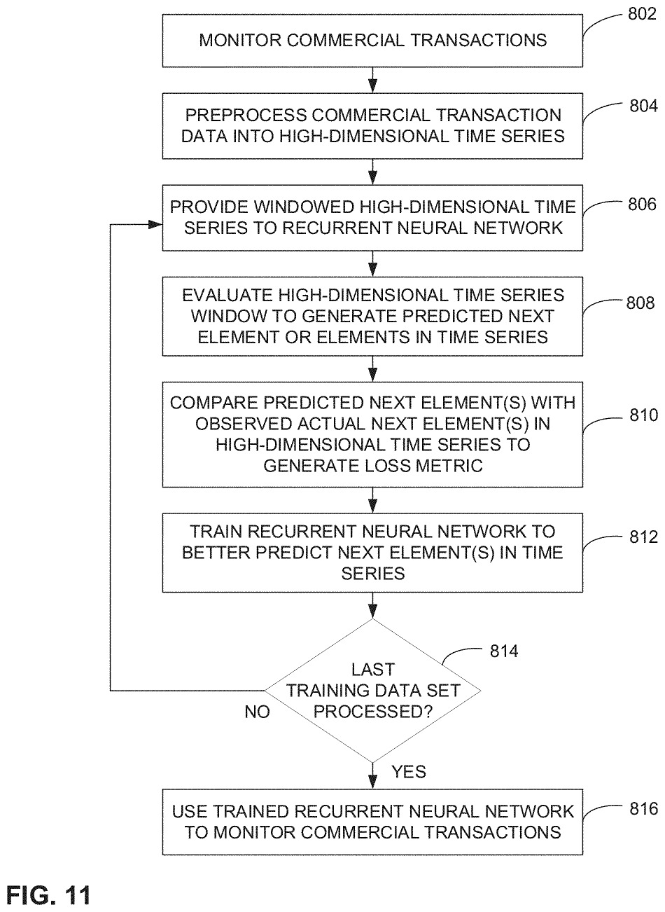

FIG. 11 is a flowchart of a method of training a recurrent neural network to identify anomalies in commercial transaction data, consistent with an example embodiment. Here, commercial transaction data is monitored, such as via a networked commerce system, at 1102. The commercial transaction data is processed into a high-dimensional time series at 1104, such as by quantifying characteristics of the network traffic that may be relevant to characterizing the commercial transactions for purposes of determining whether the transactions are normal or may include anomalies that indicate anomalous commercial activity. In a more detailed example, dimensions include a statistically large number of different metrics, such as more than 20, 30, 50, or 100 such metrics. Examples of metrics include counting the number of commercial and business events such as number of users, installations, views of advertisement, searches of products in different search providers, rolling 30 active users, or bookings and revenue.

At 1106, the high-dimensional time series is windowed, such as by taking sequential overlapping groups of the time series, incremented by a time over which patterns are likely to repeat such as a day, a week, or a month, and provided to the recurrent neural network for training. The time series window is evaluated at 1108 to generate or output a predicted next element or elements in the series, and the prediction is compared at 1110 with the actual, known next elements in the high-dimensional time series to generate a loss metric reflecting the difference. The difference or loss function is fed back into the recurrent neural network, such as through backpropagation or other such methods, and used to alter the neural network coefficients to cause the predicted next element to more closely match the actual or observed next element in the time series, thereby training the neural network to more accurately predict the next element or elements.

This process repeats at 1114 for additional windows of training data within the training data batch until the entire training data batch has been processed, at which point the trained recurrent neural network is implemented for monitoring live commercial transaction data at 1116.

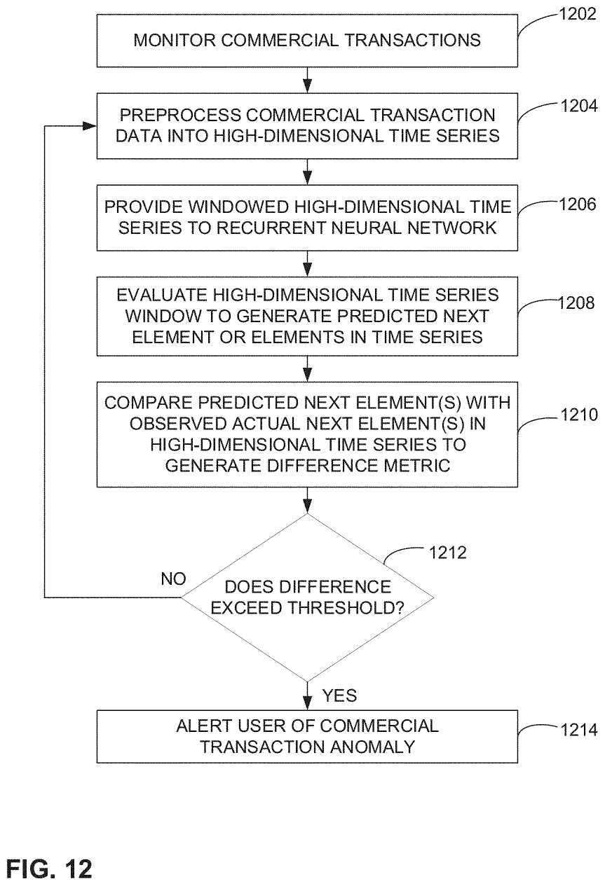

FIG. 12 is a flowchart of a method of using a trained recurrent neural network to identify anomalies in commercial transactions, consistent with an example embodiment. Here, commercial transactions are monitored at 1202, such as in a networked commerce server or by querying a database of commercial transaction data. The commercial transaction data is processed into a high-dimensional time series at 1204 and provided to a recurrent neural network at 1206, much as in the example of FIG. 11. At 1208, the high-dimensional time series windowed input is evaluated to generate an output of a predicted next element or elements in the series. At 1210, the predicted next element(s) output from the recurrent neural network are compared with the actual next element(s), and a difference metric is generated.

The difference metric is in various further examples compared against an absolute threshold, compared against a threshold determined relative to either the predicted or true network traffic data value, or evaluated using other statistical criteria such as exceeding a z-score or deviation from expected variation between the predicted and true, observed network traffic values. In another example, the difference metric and threshold are determined using long short history threshold, self-adapting dynamic threshold, or a combination of one or more of these with one or more other metrics. In a further example, the threshold is computed based on a long history, such as the last 100 or more events, to more accurately characterize typical commercial transactional data. When the prediction error exceeds the threshold or statistical criteria at 1212, it is considered an anomaly and is flagged for reporting such as to a user or administrator at 121.

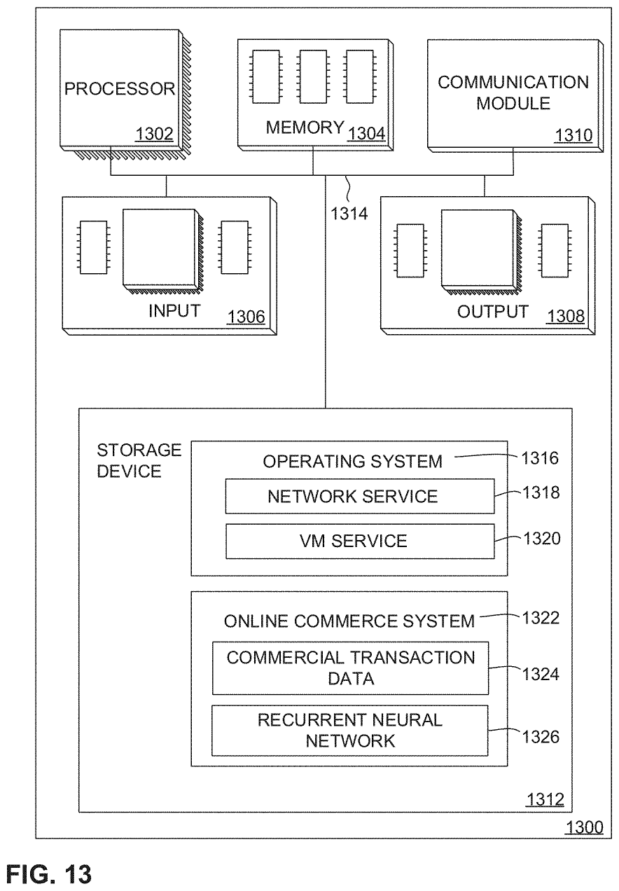

Although the network commerce server 102 uses a recurrent neural network in the examples herein, other examples will use a convolutional neural network or other neural network or artificial intelligence method to evaluate both prior and current inputs in a series of high-dimensional network traffic characteristics to predict one or more next elements in the series. The computerized systems such as the network commerce server 102 of FIG. 1 used to train the recurrent neural network can take many forms, and are configured in various embodiments to perform the various functions described herein. FIG. 13 is a computerized network commerce system comprising a recurrent neural network module, consistent with an example embodiment of the invention. FIG. 13 illustrates only one particular example of computing device 1300, and other computing devices 1300 may be used in other embodiments. Although computing device 1300 is shown as a standalone computing device, computing device 1300 may be any component or system that includes one or more processors or another suitable computing environment for executing software instructions in other examples, and need not include all of the elements shown here.

As shown in the specific example of FIG. 13, computing device 1300 includes one or more processors 1302, memory 1304, one or more input devices 1306, one or more output devices 1308, one or more communication modules 1310, and one or more storage devices 1312. Computing device 1300, in one example, further includes an operating system 1316 executable by computing device 1300. The operating system includes in various examples services such as a network service 1318 and a virtual machine service 1320 such as a virtual server. One or more applications, such as online commerce system 1322 are also stored on storage device 1312, and are executable by computing device 1300.

Each of components 1302, 1304, 1306, 1308, 1310, and 1312 may be interconnected (physically, communicatively, and/or operatively) for inter-component communications, such as via one or more communications channels 1314. In some examples, communication channels 1314 include a system bus, network connection, inter-processor communication network, or any other channel for communicating data. Applications such as online commerce system 1322 and operating system 1316 may also communicate information with one another as well as with other components in computing device 1300.

Processors 1302, in one example, are configured to implement functionality and/or process instructions for execution within computing device 1300. For example, processors 1302 may be capable of processing instructions stored in storage device 1012 or memory 1304. Examples of processors 1302 include any one or more of a microprocessor, a controller, a digital signal processor (DSP), an application specific integrated circuit (ASIC), a field-programmable gate array (FPGA), or similar discrete or integrated logic circuitry.

One or more storage devices 1312 may be configured to store information within computing device 1300 during operation. Storage device 1312, in some examples, is known as a computer-readable storage medium. In some examples, storage device 1312 comprises temporary memory, meaning that a primary purpose of storage device 1312 is not long-term storage. Storage device 1312 in some examples is a volatile memory, meaning that storage device 1312 does not maintain stored contents when computing device 1300 is turned off. In other examples, data is loaded from storage device 1312 into memory 1304 during operation. Examples of volatile memories include random access memories (RAM), dynamic random access memories (DRAM), static random access memories (SRAM), and other forms of volatile memories known in the art. In some examples, storage device 1312 is used to store program instructions for execution by processors 1302. Storage device 1312 and memory 1304, in various examples, are used by software or applications running on computing device 1300 such as online commerce system 1322 to temporarily store information during program execution.

Storage device 1312, in some examples, includes one or more computer-readable storage media that may be configured to store larger amounts of information than volatile memory. Storage device 1312 may further be configured for long-term storage of information. In some examples, storage devices 1312 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1300, in some examples, also includes one or more communication modules 1310. Computing device 1300 in one example uses communication module 1310 to communicate with external devices via one or more networks, such as one or more wireless networks. Communication module 1310 may be a network interface card, such as an Ethernet card, an optical transceiver, a radio frequency transceiver, or any other type of device that can send and/or receive information. Other examples of such network interfaces include Bluetooth, 4G, LTE, 5G, WiFi, Near-Field Communications (NFC), and Universal Serial Bus (USB). In some examples, computing device 1300 uses communication module 1310 to wirelessly communicate with an external device such as via public network 120 of FIG. 1.

Computing device 1300 also includes in one example one or more input devices 1306. Input device 1306, in some examples, is configured to receive input from a user through tactile, audio, or video input. Examples of input device 1306 include a touchscreen display, a mouse, a keyboard, a voice responsive system, video camera, microphone or any other type of device for detecting input from a user.

One or more output devices 1308 may also be included in computing device 1300. Output device 1308, in some examples, is configured to provide output to a user using tactile, audio, or video stimuli. Output device 1308, in one example, includes a display, a sound card, a video graphics adapter card, or any other type of device for converting a signal into an appropriate form understandable to humans or machines. Additional examples of output device 1308 include a speaker, a light-emitting diode (LED) display, a liquid crystal display (LCD), or any other type of device that can generate output to a user.

Computing device 1300 may include operating system 1316. Operating system 1316, in some examples, controls the operation of components of computing device 1300, and provides an interface from various applications such as online commerce system 1322 to components of computing device 1300. For example, operating system 1316, in one example, facilitates the communication of various applications such as online commerce system 1022 with processors 1302, communication unit 1310, storage device 1312, input device 1306, and output device 1308. Applications such as online commerce system 1322 may include program instructions and/or data that are executable by computing device 1300. As one example, online commerce system 1022 evaluates commercial transaction data 1324 using recurrent neural network 1326, such that the recurrent neural network when trained is operable to detect anomalies in commercial transaction data. These and other program instructions or modules may include instructions that cause computing device 1300 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying anomalous data in a sequence of commercial transaction data, comprising:
preprocessing commercial transaction data into a time series sequence of commercial transaction data;
providing the time series to a recurrent neural network;
evaluating the provided time series in the recurrent neural network to generate and output a predicted next element in the time series;
comparing the predicted next element in the time series with an observed actual next element in the time series; and
determining whether the observed next element in the time series is anomalous based on a difference between the predicted next element in the time series with an observed actual next element in the time series.

2. The method of identifying anomalous data in a sequence of commercial transaction data of claim 1, wherein the time series sequence of commercial transaction data is a high-dimensional time series sequence of commercial transaction data.

3. The method of identifying anomalous data in a sequence of commercial transaction data of claim 2, wherein the high-dimensional time series comprises 30 or more features derived from the sequence of commercial transactions during preprocessing.

4. The method of identifying anomalous data in a sequence of commercial transaction data of claim 1, wherein the recurrent neural network is configured to provide an output based on both the current input and at least one prior input in the sequence previously provided to the recurrent neural network.

5. The method of identifying anomalous data in a sequence of commercial transaction data of claim 1, wherein the recurrent neural network is trained on windowed sequences from the sequence of computer network traffic.

6. The method of identifying anomalous data in a sequence of commercial transaction data of claim 5, wherein the window comprises a multiple of a day, a week, or a month.

7. The method of identifying anomalous data in a sequence of commercial transaction data of claim 1, wherein the difference between the predicted next element in the high-dimensional time series and an observed actual next element in the high-dimensional time series comprise at least one of long short history threshold, self-adapting dynamic threshold, absolute difference, difference relative to either predicted or actual observed next element, z-score, dynamic threshold, or difference between short-term and long-term prediction error.

8. The method of identifying anomalous data in a sequence of commercial transaction data of claim 1, further comprising notifying a user upon determination that the observed next element in the time series is anomalous.

9. A computer system configured to detect anomalies in a sequence of commercial transaction data, comprising:
a processor operable to execute a series of computer instructions; and
a set of computer instructions comprising a preprocessor module, a recurrent neural network module, and an output module;
the preprocessor module operable to process commercial transaction data into a time series sequence of commercial transaction data;
the recurrent neural network module operable to receive the time series sequence of commercial transaction data from the preprocessor and to evaluate the provided time series sequence of commercial transaction data to generate and output a predicted next element in the time series sequence of commercial transaction data; and
the output module operable to compare the predicted next element in the time series sequence of commercial transaction data with an observed actual next element in the time series sequence of commercial transaction data, and to determine whether the observed next element in the time series sequence of commercial transaction data is anomalous based on a difference between the predicted next element in the time series sequence of commercial transaction data with an observed actual next element in the time series sequence of commercial transaction data.

10. The computer system of claim 9, wherein the time series sequence of commercial transaction data is a high-dimensional time series sequence of commercial transaction data.

11. The computer system of claim 10, wherein the high-dimensional time series comprises 30 or more features derived from the sequence of commercial transactions during preprocessing.

12. The computer system of claim 9, wherein the recurrent neural network module is configured to provide the output based on both the current input and at least one prior input in the sequence previously provided to the recurrent neural network.

13. The computer system of claim 9, wherein the recurrent neural network is trained on windowed sequences from the sequence of commercial transaction data.

14. The computer system of claim 13, wherein the window comprises a multiple of a day, a week, or a month.

15. The computer system of claim 9, wherein the difference between the predicted next element in the time series sequence of commercial transaction data and an observed actual next element in the time series sequence of commercial transaction data comprise at least one of long short history threshold, self-adapting dynamic threshold, absolute difference, difference relative to either predicted or actual observed next element, z-score, dynamic threshold, or difference between short-term and long-term prediction error.

16. The computer system of claim 9, the output module further operable to notify a user upon determination that the observed next element in the time series sequence of commercial transaction data is anomalous.

17. A method of training a recurrent neural network to identify anomalous traffic in a sequence of commercial transaction data, comprising:
preprocessing commercial transaction data into a time series sequence of commercial transaction data;
providing the time series to a recurrent neural network;
evaluating the provided time series in the recurrent neural network to generate and output a predicted next element in the time series;
comparing the predicted next element in the time series with an observed actual next element in the time series; and
training the recurrent neural network to better predict the next element using the loss metric by adjusting coefficients of the recurrent neural network to reduce the loss metric.

18. The method of training a recurrent neural network of claim 16, further comprising repeating the preprocessing, providing, evaluating, comparing, and training steps for a series of sequential windowed data sets derived from the commercial transaction data.

19. The method of training a recurrent neural network of claim 16, wherein the time series sequence of commercial transaction data is a high-dimensional time series sequence of commercial transaction data.

20. The method of training a recurrent neural network of claim 18, wherein the high-dimensional time series comprises 30 or more features derived from the sequence of commercial transactions during preprocessing.

21. The method of training a recurrent neural network of claim 16, wherein the difference between the predicted next element in the high-dimensional time series and an observed actual next element in the high-dimensional time series comprise at least one of long short history threshold, self-adapting dynamic threshold, absolute difference, difference relative to either predicted or actual observed next element, z-score, dynamic threshold, or difference between short-term and long-term prediction error.
